(19) United States
(12) Patent Application Publication
(10) Pub. No.: US 2019/0362107 A1
(43) Pub. Date: Nov. 28, 2019

(54) ADVANCED PERIPHERAL BUS BASED INTER-INTEGRATED CIRCUIT COMMUNICATION DEVICE

(71) Applicant: C-SKY Microsystems Co. Ltd., Hangzhou, Zhejiang (CN)

(72) Inventors: Jiaqi ZHU, Hangzhou (CN); Youfei WU, Hangzhou (CN); Bo SUN, Hangzhou (CN); Benzhang WANG, Hangzhou (CN)

(21) Appl. No.: 16/479,401

(22) PCT Filed: Dec. 19, 2018
(86) PCT No.: PCT/CN2018/122082

§ 371 Date: Jul. 19, 2019

(30) Foreign Application Priority Data
Dec. 19, 2017 (CN) 201711376965.0

(51) Int. Cl. G06F 21/85; G06F 13/20; G06F 13/42; G06F 21/60; H04L 9/06

(52) U.S. Cl. CPC G06F 21/85; G06F 13/20; G06F 13/4282; G06F 2213/0016; G06F 21/602; H04L 9/0618; G06F 21/606

(57) ABSTRACT

An APB (Advanced Peripheral Bus) bus-based I2C (Inter-Integrated Circuit) communication device is provided. The device comprises: an APB interface module (1), an I2C bus interface module (2), an encryption module (3), a decryption module (4), and a control module (5), wherein the encryption module (3) receives plaintext data and a key from a master via the APB interface module (1), generates, when enabled, ciphertext data according to the plaintext data and the key, and sends the ciphertext data to a slave via the I2C bus interface module (2); the decryption module (4)receives the ciphertext data from the slave via the I2C bus interface module (2) and receives a key from the master via the APB interface module (1), generates, when enabled, plaintext data according to the ciphertext data and the key, and sends the plaintext data to the master via the APB interface module (1). The device can improve the security of data transmission.

### CROSS REFERENCE TO RELATED APPLICATION

This disclosure claims the benefits of priority to Chinese application number 201711376965.0, filed Dec. 19, 2017, which is incorporated herein by reference in its entirety.

### BACKGROUND

Inter-integrated circuit (I2C) bus is a simple, bidirectional, two-wire synchronous serial bus, and has functions required by multi-master systems, including bus arbitration and synchronization of high and low-speed devices. Its range of applications is very broad, such as computer peripherals, industrial control, and the like. One of the limitations of conventional I2C communication devices is that it can only transmit plaintext data. There is a need to develop a more secure I2C communication device.

### SUMMARY OF DISCLOSURE

Embodiments of the present disclosure provide a device for APB (Advanced Peripheral Bus) bus-based I2C communications. The device can include: an advanced bus interface module configured to be connected to an APB of the master; an I2C bus interface module configured to be connected to an I2C bus of the slave; an encryption module configured to receive plaintext data and a key from the master and generate ciphertext data; a decryption module configured to receive the ciphertext data from the slave and receive a key from the master and generate plaintext data; and a control module configured to control the encryption module, the decryption module, and the I2C bus interface module. When the master writes data into the slave, the transmitted plaintext data is encrypted through the encryption module, and when the master reads encrypted data stored in the slave, the encrypted data is decrypted through the decryption module. Compared with conventional systems, the present disclosure can perform encryption and decryption on transmitted data through hardware in I2C communications, transmit ciphertext data, and improve the security of data transmission. Meanwhile, the hardware resources according to the present disclosure are simple and easy to implement.

### BRIEF DESCRIPTION OF THE DRAWINGS

FIG. 1 is a schematic diagram of a conventional APB bus-based I2C communication device.

FIG. 2 is a schematic diagram of an exemplary APB bus-based I2C communication device, according to some embodiments of the present disclosure.

FIG. 3 is a schematic diagram of an exemplary APB bus-based I2C communication device, according to some embodiments of the present disclosure.

FIG. 4 is an exemplary timing diagram of data writing by an APB, according to some embodiments of the present disclosure.

FIG. 5 is an exemplary timing diagram of data reading by an APB, according to some embodiments of the present disclosure.

FIG. 6 is an exemplary schematic diagram of an I2C transmitted data frame format, according to some embodiments of the present disclosure.

FIG. 7 is a schematic diagram of an exemplary circuitry within the encryption module, according to some embodiments of the present disclosure.

FIG. 8 is a schematic diagram of an exemplary circuitry within the decryption module, according to some embodiments of the present disclosure.

### DETAILED DESCRIPTIONS

To illustrate the objectives, technical solutions, and advantages of embodiments of the present disclosure more clearly, the technical solutions in the embodiments of the present disclosure are described below with reference to the accompanying drawings in the embodiments of the present disclosure. It is apparent that the described embodiments are merely some, rather than all, of the embodiments of the present disclosure. Based on the embodiments of the present disclosure, all other embodiments obtainable by a person skilled in the art without creative efforts should belong to the protection scope of the present disclosure.

A conventional I2C communication device typically includes a master-side bus interface part, an I2C bus interface module, and a control module. The I2C bus interface module comprises an I2C control module and a sending/receiving module, which may be of a dual-cache structure. The master-side bus interface part may use an APB (Advanced Peripheral Bus) structure. An example of the conventional I2C communication device is shown in FIG. 1.

Conventional I2C communication devices can only transmit plaintext data and cannot meet the requirements for secure communications in some communication fields requiring high security, such as information security cards, military fields, and the like. Therefore, there is a need to develop a more secure I2C communication device.

To overcome the issues with conventional devices, the disclosed embodiments describe a device that enables encryption and decryption of data, thereby providing I2C communications that are more secure.

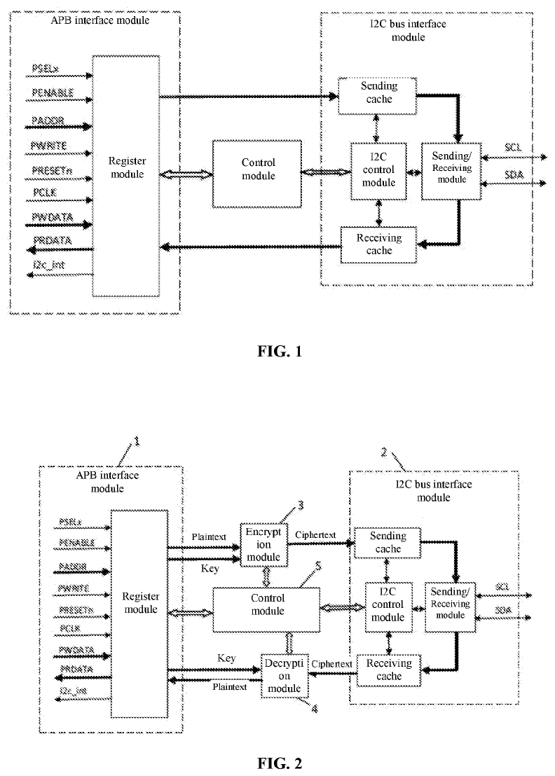

Some embodiments of the present disclosure provide an advanced bus-based I2C communication device for I2C communications between a master and a slave. FIG. 2 is a schematic diagram of an APB bus-based I2C communication device, according to some embodiments of the present disclosure. As shown in FIG. 2, the device comprises APB interface module 1, I2C bus interface module 2, encryption module 3, decryption module 4, and control module 5.

APB interface module 1 comprises an interrupt request signal line and all signal lines defined by an APB. APB interface module 1 is connected to an APB of the master (not shown) and is responsible for communications with the master. The APB is defined by the AMBA (Advanced Microcontroller Bus Architecture) protocol.

I2C bus interface module 2 comprises two signal lines of dual-direction data signal SDA for receiving and sending data and clock signal SCL. I2C bus interface module 2 is connected to an I2C bus of the slave and is responsible for communications with the I2C slave.

Encryption module 3 receives plaintext data and a key from the master via APB interface module 1. Encryption module 3 is subject to the enabling control by control module 5. When enabled by control module 5, encryption module 3 generates ciphertext data according to the plaintext data and the key and sends the ciphertext data to the slave via I2C bus interface module 2.

Decryption module 4 receives the ciphertext data from the slave via I2C bus interface module 2 and receives a key from the master via APB interface module 1. Decryption module 4 is subject to the enabling control by control module 5. When enabled by control module 5, decryption module 4 generates plaintext data according to the ciphertext data and the key and sends the plaintext data to the master via APB interface module 1.

Control module 5 receives a control instruction from the master via APB interface module 1. According to the control instructions, control module 5 can control encryption module 3 decryption module 4, and I2C bus interface module 2 and feeds a state signal of control module 5 back to the master via APB interface module 1.

In some embodiments, the slave functions as a memory, such as a memory chip EEPROM related to I2C. The master can write data into the slave; alternatively, the master can read data stored in the slave.

With the APB bus-based I2C communication device provided in the embodiments of the present, when the master writes data into the slave, the transmitted plaintext data is encrypted through the encryption module. When the master reads encrypted data stored in the slave, the encrypted data is decrypted through the decryption module. Compared with conventional systems, embodiments of the present disclosure can perform encryption and decryption on transmitted data through hardware in I2C communications, transmit ciphertext data, and improve the security of data transmission.

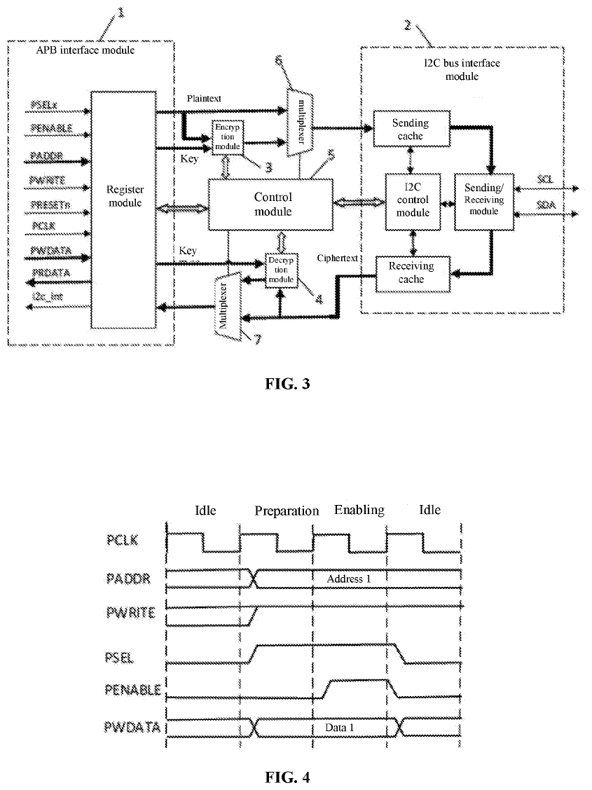

FIG. 3 is a schematic diagram of an APB bus-based I2C communication device, according to some embodiments of the present disclosure. As shown in FIG. 3, the APB bus-based I2C communication device comprises two 2-to-1 multiplexers 6 and 7. For example, multiplexers are 8 bits. Multiplexer 6 works with encryption module 3, and multiplexer 7 works with decryption module 4.

Multiplexer 6 receives as input the plaintext data from APB interface module 1 and the ciphertext data outputted by encryption module 3, and selects to output either the plaintext data or the ciphertext data as controlled by control module 5. If encryption module 3 is enabled, control module 5 controls to select outputting the ciphertext data to I2C bus interface module 2. On the other hand, if encryption module 3 is not enabled, the key from the master is invalid and control module 5 controls to select outputting the plaintext data to I2C bus interface module 2.

Multiplexer 7 receives as input the ciphertext data from I2C bus interface module 2 and the plaintext data outputted by decryption module 4, and selects to output either the plaintext data or the ciphertext data as controlled by control module 5. If decryption module 4 is enabled, control module 5 controls to select outputting the plaintext data after decryption to APB interface module 1. On the other hand, if decryption module 4 is not enabled, the key from the master is invalid and control module 5 controls to select outputting the received ciphertext data to APB interface module 1.

The working principle of the APB bus-based I2C communication device provided in some embodiments of the present disclosure is introduced in detail below.

APB interface module 1 comprises an interrupt request signal i2c_int and all signal lines defined by the APB. The interrupt request signal i2c_int stays at a low level when there is no interrupt request, and stays high when an interrupt request occurs.

In an idle state, both the select signal (PSEL) and the enable signal (PENABLE) are low, and data (PDATA) and address (PADDR) are invalid.

When one APB write operation takes place, a timing sequence can occur based on the diagram shown in FIG. 4. In the preparation period, the master has the data (PWDATA) and address (PADDR) ready, and at the same time, sets the select signal (PSEL) to high. In the enabling period, the enable signal (PENABLE) is set to high. These signals are maintained until the rising edge at the end of the enabling period. And at this rising edge, data is written into a corresponding register according to the address.

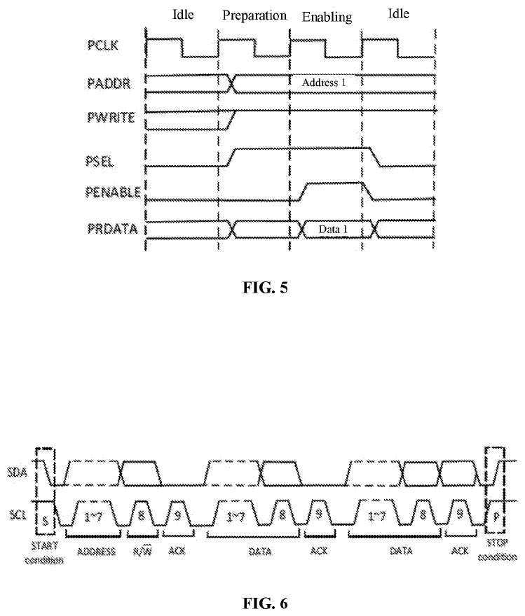

When one APB read operation takes place, a timing sequence can occur based on the diagram shown in FIG. 5. In the preparation period, the master has the address (PADDR) ready, and at the same time, sets the select signal (PSEL) to high. In the enabling period, the enable signal (PENABLE) is set to high. At the same time, the APB interface module has the data (PRDATA) ready according to the address. These signals are maintained until the rising edge at the end of the enabling period, and at this rising edge, the master reads the data.

The I2C bus interface module 2 supports a 7-bit addressing mode and a 10-bit addressing mode that can be configured through programming. Moreover, the transmission rate can also be configured through programming. For example, the transmission rate supports an SS (standard speed) mode, an FS (fast speed) mode, and a HS (high speed) mode. Each frame of data comprises of a START condition, 7-bit or 10-bit address bits, ACK bit, data bit, and a STOP condition. FIG. 6 provides an exemplary detailed format for I2C transmitted data frame.

When data is being sent, the I2C control module configures the I2C communication device as a master device. Parallel data is read from the sending cache and written into the sending/receiving module. Parallel to serial conversion is performed in the sending/receiving module. A clock signal is sent via SCL. The address data of the slave device is first sent via SDA in a serial manner, and then the data to be sent is sent in a serial manner.

When data is being received, the I2C communication device is configured as a master device. The sending/receiving module sends a clock signal via SCL. The address of the slave device to read data is sent via SDA in a serial manner, then a read request is sent. The data is sent via SDA after the slave device matches the address and the read request, and the sending/receiving module in the I2C device stores the received data into the receiving cache.

An example is provided below for encryption module 3 and decryption module 4. The example uses the hardware bitstream encryption method, which only indicates the feasibility of the modules, and the specific implementation is not limited to this method.

Encryption module 3 in the example generates ciphertext data according to the plaintext data and the key. The plaintext data and the ciphertext data have the same width, which can be 8 bits, 16 bits, 32 bits, or 64 bits, and the key has a width of 32 bits, 64 bits, 128 bits, or 256 bits. The plaintext data and ciphertext data in the example are 8-bit.

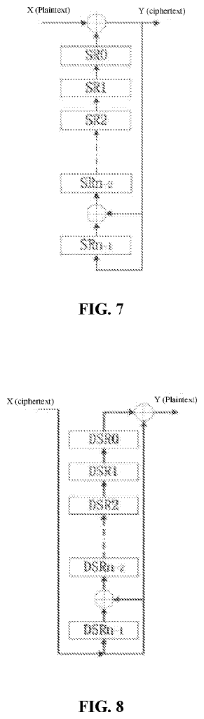

FIG. 7 is a schematic diagram of some exemplary circuitry within the encryption module, according to some embodiments of the present disclosure. For example, 8 groups of the circuitry shown in FIG. 7 jointly form the encryption module 3 and complete one encryption of an 8-bit data within one clock period.

In the example, when the key has 32 bits, n=4. In such an example, the circuitry shown in FIG. 7 would comprise 4 SR registers and 2 adders. The initial values of the 4 SR registers are 4 bits of the key (the 1^{st} bit of the plaintext data corresponds to bits 1-4 of the key, the 2^{nd} bit of the plaintext data corresponds to bits 5-8 of the key, . . . , so on and so forth, and the 8^{th} bit of the plaintext data corresponds to bits 29-32 of the key).

When the key has 64 bits, n=8, and the circuitry shown in FIG. 7 would comprise 8 SR registers and 2 adders. The initial values of the 8 SR registers are 8 bits of the key (the 1^{st} bit of the plaintext data corresponds to bits 1-8 of the key, the 2^{nd} bit of the plaintext data corresponds to bits 9-16 of the key, . . . , so on and so forth).

When the key has 128 bits, n=16, and the circuitry shown in FIG. 7 would comprise 16 SR registers and 2 adders. The initial values of the 16 SR registers are 16 bits of the key (the 1^{st} bit of the plaintext data corresponds to bits 1-16 of the key, the 2^{nd} bit of the plaintext data corresponds to bits 17-32 of the key, . . . , so on and so forth).

When the key has 256 bits, n=32, and the circuitry shown in FIG. 7 would comprise 32 SR registers and 2 adders. The initial values of the 32 SR registers are 32 bits of the key (the 1^{st} bit of the plaintext data corresponds to bits 1-32 of the key, the 2^{nd} bit of the plaintext data corresponds to bits 33-64 of the key, . . . , so on and so forth).

When 1 bit of the plaintext data is encrypted, the ciphertext Y=X+SR0 is outputted and written back into SRn−1. SRn−2=SRn−1+Y, and the other SR0−SRn−3 are all SR(i−1)=SR(i), where i is 1 to n−2.

Decryption module 4 in the example generates plaintext data according to the ciphertext data and the key. The plaintext data and the ciphertext data have the same width, which can be 8 bits, 16 bits, 32 bits, or 64 bits, and the key has a width of 32 bits, 64 bits, 128 bits, or 256 bits. The plaintext data and ciphertext data in the example are 8-bit.

FIG. 8 is a schematic diagram of some exemplary circuitry within the decryption module, according to some embodiments of the present disclosure. The circuitry shown on FIG. 8 jointly form the decryption module 4 and complete one decryption of an 8-bit data within one clock period.

In the example, when the key has 32 bits, n=4. In such an example, the circuitry shown in FIG. 8 comprise 4 DSR registers and 2 adders. The initial values of the 4 DSR registers are 4 bits of the key (the 1^{st} bit of the ciphertext data corresponds to bits 1-4 of the key, the 2^{nd} bit of the ciphertext data corresponds to bits 5-8 of the key, . . . , so on and so forth, and the 8^{th} bit of the ciphertext data corresponds to bits 29-32 of the key).

When the key has 64 bits, n=8, and the circuitry shown in FIG. 8 would comprise 8 DSR registers and 2 adders. The initial values of the 8 DSR registers are 8 bits of the key (the 1^{st} bit of the ciphertext data corresponds to bits 1-8 of the key, the 2^{nd} bit of the ciphertext data corresponds to bits 9-16 of the key, . . . , so on and so forth).

When the key has 128 bits, n=16, and the circuitry shown in FIG. 8 would comprise 16 DSR registers and 2 adders. The initial values of the 16 DSR registers are 16 bits of the key (the 1^{st} bit of the ciphertext data corresponds to bits 1-16 of the key, the 2^{nd} bit of the ciphertext data corresponds to bits 17-32 of the key, . . . , so on and so forth).

When the key has 256 bits, n=32, and the circuitry shown in FIG. 8 would comprise 32 DSR registers and 2 adders. The initial values of the 32 DSR registers are 32 bits of the key (the 1st bit of the ciphertext data corresponds to bits 1-32 of the key, the 2^{nd} bit of the ciphertext data corresponds to bits 33-64 of the key, . . . , so on and so forth).

When 1 bit of the ciphertext data is decrypted, the plaintext Y=X+DSR0 is outputted, and at the same time, X is written into DSRn−1. DSRn−2=DSRn−1+X, and the other DSR0−DSRn−3 are all DSR(i−1)=DSR(i), where i is 1 to n−2.

With the above encryption module and decryption module, ciphertext data can be transmitted in I2C communications between the master and the slave, which improve the security of data transmission.

It is appreciated that all or some processes in the method according to the above embodiments can be implemented through a computer program instructing relevant hardware. The program can be stored in a computer readable storage medium. During execution, the program can comprise processes of the embodiments of the above methods, wherein the storage medium can be magnetic disks, optical disks, Read-Only Memory (ROM), Random Access Memory (RAM), and the like.

Some specific embodiments of the present disclosure are described above, but the protection scope of the present disclosure is not limited to these embodiments. Any variation or substitution that can be easily conceived of by a person skilled in the art within the technical scope of the present disclosure shall fall within the protection scope of the present disclosure. Therefore, the protection scope of the present disclosure shall be subjected to the protection scope of the claims.

1. A device for integrated-circuit communications between a master and a slave, comprising:
a first interface module communicatively coupled to an advanced bus of the master;
a second interface module communicatively coupled to a bus of the slave;
an encryption module configured to receive plaintext data and a key from the master via the first interface module, to generate ciphertext data according to the plaintext data and the key, and to send the ciphertext data to the slave via the second interface module; and
a decryption module configured to receive the ciphertext data from the slave via the second interface module, to receive a key from the master via the first interface module, to generate plaintext data according to the ciphertext data and the key, and to send the plaintext data to the master via the first interface module.

2. The device of claim 1, wherein the advanced bus is an Advanced Peripheral Bus (APB).

3. The device according to claim 1, further comprising a control module configured to receive a control instruction from the master via the first interface module, control the encryption module, the decryption module, and the second interface module, and feed a state signal back to the master via the first interface module.

4. The device according to claim 3, further comprising a 2-to-1 multiplexer configured to receive the plaintext data inputted from the first interface module and the ciphertext data outputted by the encryption module and to select to output the plaintext data or the ciphertext data as controlled by the control module.

5. The device according to claim 3, further comprising a 2-to-1 multiplexer configured to receive the ciphertext data inputted from the second interface module and the plaintext data outputted by the decryption module and to select to output the plaintext data or the ciphertext data as controlled by the control module.

6. The device according to claim 1, wherein the encryption module comprises adders and SR (scramble register) registers.

7. The device according to claim 1, wherein the decryption module comprises adders and DSR (descramble register) registers.

8. The device according to claim 1, wherein the plaintext data and the ciphertext data have a width of 8 bits, 16 bits, 32 bits, or 64 bits.

9. The device according to claim 1, wherein the key has a width of 32 bits, 64 bits, 128 bits, or 256 bits.

10. The device according to claim 1, wherein the slave is a memory having an I2C bus.

11. The device according to claim 1, wherein the first interface module comprises an interrupt request signal line and an APB defined by AMBA (Advanced Microcontroller Bus Architecture) protocol.

12. The device according to claim 1, wherein the second interface module comprises a data transmitting signal line and a clock signal line.
